(19) United States
(12) Patent Application Publication
(10) Pub. No.: US 2026/0094758 A1
(43) Pub. Date: Apr. 2, 2026

(54) TRANSFORMER APPARATUS

(71) Applicant: Eaton Intelligent Power Limited, Dublin (IE)

(72) Inventor: Samuel T. Reed, Hartland, WI (US)

(21) Appl. No.: 19/338,759

(22) Filed: Sep. 24, 2025

Related U.S. Application Data
(60) Provisional application No. 63/701,762, filed on Oct. 1, 2024.

(51) Int. Cl. H01F 27/32; H01F 27/34; H01F 27/40

(52) U.S. Cl. CPC H01F 27/321; H01F 27/34; H01F 27/402; H01F 2027/404

(57) ABSTRACT

A system includes: a housing that defines an interior configured to receive an electrically insulating fluid; a transformer including an electrically conductive coil assembly in the interior; a switching assembly in the interior, the switching assembly including: an input side; an output side; and a switch device that electrically connects the input side and the output side in a closed state and electrically isolates the input side and the output side in an opened state; a connection assembly that passes through the housing; a flexible electrical connection that electrically connects the connection assembly and the input side of the switching assembly; a rigid electrically conductive bus electrically connected to the output side of the switching assembly; and electrically conductive cable electrically connected to the rigid electrically conductive bus and the transformer.

### CROSS-REFERENCE TO RELATED APPLICATION

This application claims priority to U.S. Provisional Application No. 63/701,762, filed Oct. 1, 2024 and titled TRANSFORMER APPARATUS, which is incorporated herein by reference in its entirety.

### TECHNICAL FIELD

This disclosure relates to a transformer apparatus for use in, for example, a medium-voltage or high-voltage electrical power distribution network.

### BACKGROUND

A voltage transformer includes a first coil and a second coil that are coupled by a magnetic core. The voltage transformer may reduce the voltage at the input of the transformer so that the output of the transformer is suitable for a load or increase (step up) the voltage so the output is suitable for transmission or distribution.

### SUMMARY

In one aspect, a system includes: a housing that defines an interior configured to receive an electrically insulating fluid; a transformer including an electrically conductive coil assembly in the interior; a switching assembly in the interior, the switching assembly including: an input side; an output side; and a switch device that electrically connects the input side and the output side in a closed state and electrically isolates the input side and the output side in an opened state; a connection assembly that passes through the housing; a flexible electrical connection that electrically connects the connection assembly and the input side of the switching assembly; a rigid electrically conductive bus electrically connected to the output side of the switching assembly; and electrically conductive cable electrically connected to the rigid electrically conductive bus and the transformer.

Implementations may include one or more of the following features.

The electrically conductive coil assembly, the rigid electrically conductive bus, and the electrically conductive cable may be associated with a first resonant frequency; and the switching assembly may be associated with a second resonant frequency that is different from the first resonant frequency. The first resonant frequency may depend on an inductance of the electrically conductive coil assembly and a spatial distance between a portion of the housing configured to be grounded during use and the rigid electrically conductive bus. The second resonant frequency may be associated with a voltage transient produced by a switching operation of the switching assembly. The second resonant frequency may be a fundamental frequency of the voltage transient produced by the switching operation of the switching assembly.

The switching assembly may include vacuum interrupters, each of the vacuum interrupters including a moving contact and a stationary contact.

The connection assembly may include bushings, and each of the bushings includes an electrical conductor that is electrically connected to the flexible electrical connection.

In another aspect, a transformer includes: a housing including: a wall configured to be grounded during use of the transformer, an interior, and a bushing that extends through the wall; a vacuum interrupter in the interior; an electromagnetic circuit in the interior, the electromagnetic circuit including an electrically conductive coil; a flexible electrical connection assembly in the interior, the flexible electrical connection electrically connected to the bushing and to a first electrical terminal of the vacuum interrupter; and an electrical lead assembly in the interior and including a rigid electrically conductive bus, the electrical lead assembly electrically connected to a second electrical terminal of the vacuum interrupter and to the electromagnetic circuit. The electrical lead assembly and the electrically conductive coil are associated with a first resonant frequency, the vacuum interrupter is associated with a second resonant frequency, and the electrical lead assembly is positioned in the interior relative to the wall such that the first resonant frequency and the second resonant frequency are not the same.

Implementations may include one or more of the following features.

The second resonant frequency may be based on the rate of rise of restrike voltage (RRRV) of the vacuum interrupter.

The second resonant frequency may be a fundamental frequency of a voltage transient produced by one or more of opening and closing the vacuum interrupter.

The electrical lead assembly also may include electrically conductive cables.

Implementations of any of the techniques described herein may include an apparatus, a method, or a system. The details of one or more implementations are set forth in the accompanying drawings and the description below. Other features will be apparent from the description and drawings, and from the claims.

### DRAWING DESCRIPTION

FIG. 1A is a perspective exterior view of a transformer apparatus.

FIG. 1B is a block diagram of an electrical system that includes the transformer apparatus of FIG. 1A.

FIG. 1C is a block diagram of a system that includes a dual-source transformer apparatus.

FIG. 2A shows an interior of a transformer apparatus.

FIG. 2B is a side cross-sectional block diagram of a vacuum fault interrupter.

FIG. 3 is a side cross-sectional view of a three-phase transformer apparatus.

### DETAILED DESCRIPTION

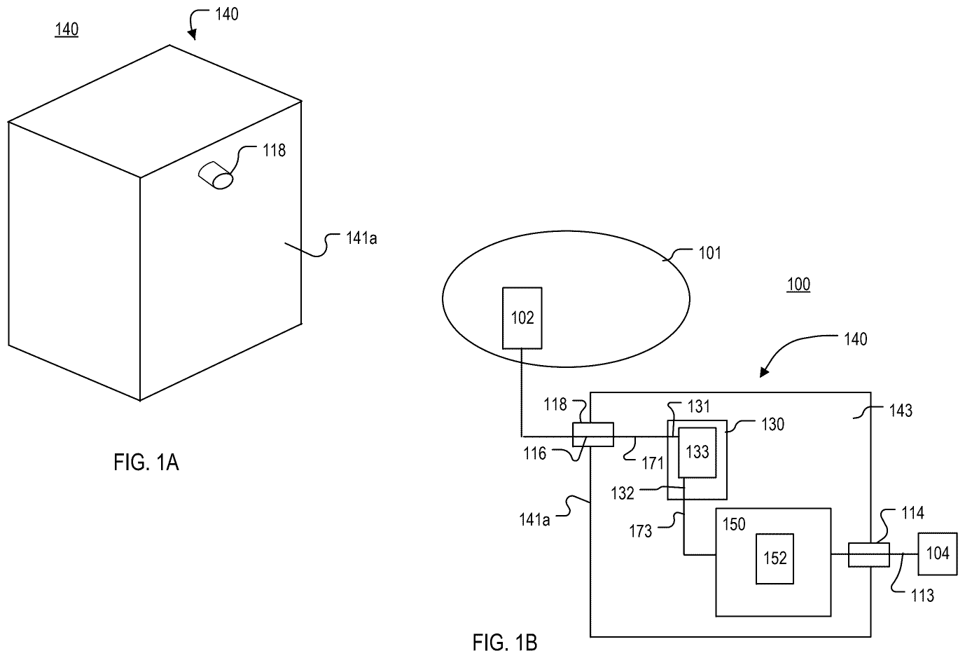

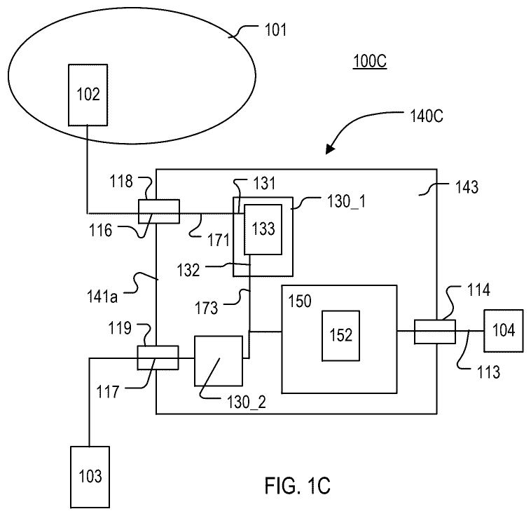

FIG. 1A is a perspective exterior view of a transformer apparatus 140. The transformer apparatus 140 may be used in medium-voltage (for example, 15 to 35 kilo Volts (kV)) and high-voltage (for example, greater than 45 kV) applications. The transformer apparatus 140 includes a housing 141. FIG. 1B is a block diagram of an electrical system 100 that includes the transformer apparatus 140. FIG. 1B shows a cross-sectional side block diagram of an interior 143 of the housing 141.

The transformer apparatus 140 includes a switching assembly 130 and an electromagnetic circuit 150 that includes an electrically conductive coil assembly 152 in the interior 143. The electromagnetic circuit 150 may be, for example, a transformer or a voltage regulator. The switching assembly 130 includes an input side 131, an output side 132, and a switch device 133 that opens to interrupt current flow through the switching assembly 130 and closes to allow current to flow through the switching assembly 130.

The transformer apparatus 140 includes a bushing 118 that electrically insulates a conductor that passes through a side 141a of the housing 141. The input side 131 of the switching assembly 130 is electrically connected to the conductor 116 by a first electrical connection assembly 171. The output side 132 of the switching assembly 130 is electrically connected to the electromagnetic circuit 150 by a second electrical connection assembly 173. The output of the electromagnetic circuit 150 is connected to a load 104 by an electrical connection 113. In the example shown, the electrical connection 113 passes through a bushing 114 on a side of the housing 141 opposite the side 141a.

In operational use, a node 102 is electrically connected to the conductor 116 and the side 141a of the housing 141 is grounded. When the switching assembly 130 is closed (or in a closed state), electrical energy can flow between the node 102 and the load 104. When the switch device 133 is open (or in an opened state), electrical energy cannot flow between the node 102 and the load 104. During normal and typical operation of the system 100, the switch device 133 is closed but can be opened to interrupt fault currents, to allow for planned maintenance of the transformer apparatus 140 and/or equipment downstream or upstream of the apparatus 140, or to address other temporary issues. After the temporary condition has ended, the switch device 133 is closed again to resume normal and typical operation of the system 100.

Opening and closing the switch device 133 produces transient voltage spikes (referred to as switching transients). The amplitude of the switching transients can be quite high and (particularly if undampened or unsmoothed) can expose the electrically conductive coil assembly 152 to high voltage. The high voltage can stress the coil assembly 152 and can lead to premature degradation or failure of the electromagnetic circuit 150. These effects can be multiplied when the resonant frequency of the switching transient matches the resonant frequency of an inductance-capacitance (L-C) circuit between the switching assembly 130 and the electromagnetic circuit 150, where the L-C circuit includes the inductance and capacitance of the second electrical connection assembly 173 and of the electromagnetic circuit 150.

On the other hand, the configuration and arrangement of the transformer apparatus 140 is such that the resonant frequency of the L-C circuit is intentionally different than the fundamental frequency of the switching transient. As a result, damage that the switching transient could otherwise cause the electromagnetic circuit 150 is reduced or eliminated. As discussed below, the placement of the first and second electrical connection assemblies 171 and 173 relative to the grounded side 141a along with the characteristics of the electrically conductive coil assembly 152 determine the inductance (L) and capacitance (C) values of the L-C circuit. The characteristics of the switching transient associated with the switch device 133 is known, for example, through manufacturing data and/or testing. With knowledge of these parameters, the various components of the transformer apparatus 140 are configured and arranged such that the resonant frequency of the L-C circuit is not the same as the fundamental frequency of the switching transient, thereby minimizing or reducing damage caused by the switching transients and prolonging the life of the transformer apparatus 140.

Before discussing the arrangement of the transformer apparatus 140 further, an overview of the system 100 and a system 100C (FIG. 1C) are provided.

The node 102 is part of an alternating current (AC) power distribution system 101. The power distribution system 101 may be, for example, an electrical grid, a utility system, an electrical system, or a multi-phase electrical network that distributes electrical power to industrial, residential, and/or commercial entities. The power distribution system 101 may be a sub-system of a larger power system. For example, the power distribution system 101 may be a utility substation. In another example, the power distribution system 101 may be a micro-grid that can be connected to and disconnected from a larger power grid. The power distribution system 101 may have a system level voltage of, for example, at least 1 kilovolt (kV), 25 kV, 27, kV, 29 kV, between 15 kV and 35 kV, up to 34.5 kV, up to 38 kV, up to 69 kV, or 69 kV or higher and a fundamental frequency of, for example, 50 or 60 Hertz (Hz).

The node 102 is any node or device in the power distribution system 110. For example, the node 102 may be a generator, a renewable energy source, or a node on a power line. The load 104 is any device or system that consumes electricity. For example, the load 104 may be a lighting system, a transformer, a heating and ventilation system, one or more motors, or a power converter.

The switching assembly 130 is any type of trippable and/or openable device that utilizes a mechanical and/or electronic mechanism to separate current-carrying electrical contacts for the purpose of interrupting the flow of electricity. The switching assembly 130 may be, for example, a vacuum fault interrupter (VFI), circuit breaker, circuit switch, loadbreak switch, vacuum breaker, vacuum switch, gas-insulated breaker, contactor, or recloser. Examples of gas-insulated breakers include, but are not limited to, sulfur hexafluoride (SF₆) insulated breakers and air-insulated breakers.

Moreover, although a single phase is shown in FIGS. 1A and 1B, the transformer apparatus 140 may be a multi-phase (for example, three-phase) apparatus. In these implementations, the switching assembly 130 includes one switch device 133 and one electromagnetic circuit 150 for each phase. In multi-phase implementations, the switch devices 133 in the switching assembly 130 may be gang-operated devices, multiple individually operated single-phase devices, or a combination of single-phase and multi-phase devices. A gang-operated switching device is configured to interrupt or switch more than one phase simultaneously.

Furthermore, and referring also to FIG. 1C, other configurations of the transformer apparatus 140 are possible and the transformer apparatus 140 may be used in the power distribution system 110 in ways other than shown in FIG. 1B. For example, FIG. 1C shows a transformer apparatus 140C, which is a dual-source configuration.

The transformer apparatus 140C is similar to the transformer apparatus 140, except the transformer apparatus 140C includes two switching devices 130_1 and 130_2, each of which is an instance of the switching assembly 130. The input side 131 of the switching assembly 130_1 is electrically connected to the conductor 116 via the first electrical connection assembly 171. The output side 132 of the switching assembly 130_2 is electrically connected to the second electrical connection assembly 173. The second electrical connection assembly 173 is electrically connected to the electromagnetic circuit 150 and to the output side of the switching assembly 130_2. The input side of the switching assembly 130_2 is electrically connected to a conductor 117 that passes through a bushing 119 on the side 141a. In operational use, the conductor 116 is connected to the node 102 and the conductor 117 is connected to a node 103. The nodes 102 and 103 are points in the power distribution system 110. The nodes 102 and 103 may be medium-voltage connection points in the power distribution system 110.

A single phase is shown in FIG. 1C, but the transformer apparatus 140C may be a multi-phase (for example, three-phase) apparatus. In these implementations, each the switching assembly 130_1 and 130_2 includes one switch device 133 and one electromagnetic circuit 150 for each phase. Thus, in a three-phase implementation, the transformer apparatus 140C includes six switching devices 133. In multi-phase implementations, the switch devices 133 in each of the switching assemblies 130_1 and 130_2 may be gang-operated devices, multiple individually operated single-phase devices, or a combination of single-phase and multi-phase devices. A gang-operated switching device is configured to interrupt or switch more than one phase simultaneously.

The housing 141 is a three-dimensional body that is made of a rugged and durable material. For example, the housing 141 may be made of metal, such as steel. In the example shown in FIG. 1A, the housing 141 is a parallelepiped that includes six walls. However, the housing 141 may be a cylinder or a shape other than a parallelepiped. The transformer apparatus 140 and the transformer apparatus 140C may include additional components and system that are not shown in FIGS. 1A-IC. For example, the transformer apparatus 140 and/or the transformer apparatus 140C may include a control system, sensors, and/or communications equipment.

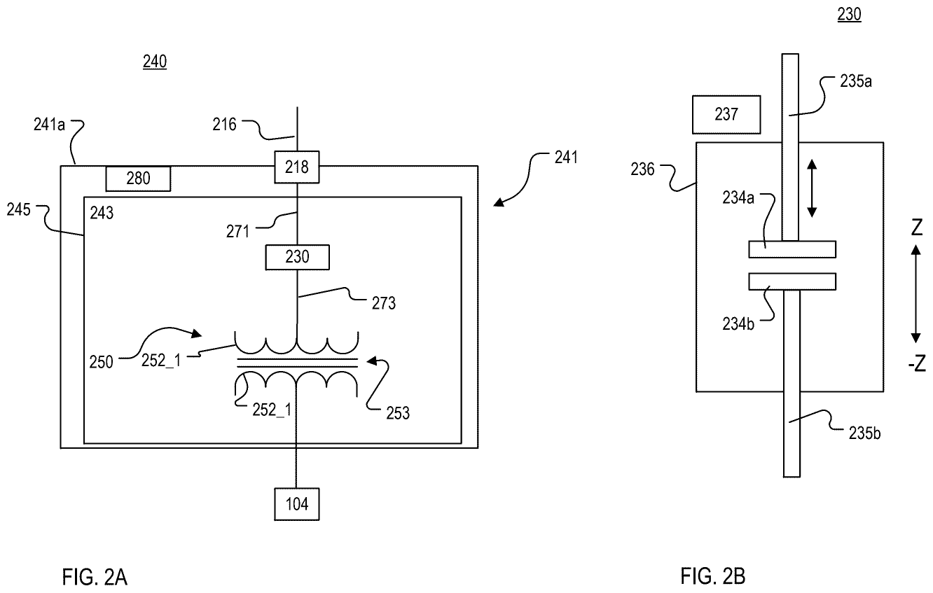

FIG. 2A shows an interior 243 of a transformer apparatus 240 that includes a housing 241. The housing 241 is a three-dimensional body that encloses a tank 245. The tank 245 is a three-dimensional and substantially hollow body that defines the interior 243. The transformer apparatus 240 includes an input bushing 218 that passes through a wall 241a of the housing 241. The wall 241a is grounded during use of the transformer apparatus 240, and the bushing 218 electrically insulates a conductor 216 that passes through the wall 241a.

The transformer apparatus 240 includes a vacuum fault interrupter (VFI) 230 and a transformer 250 in the interior 243. In addition to containing the VFI 230 and the transformer 250, the interior 243 may be filled with an electrically insulating material or an insulating fluid, such as, for example, oil. The transformer 250 includes a first electrically conductive coil 252_1, a second electrically conductive coil 252_2, and a magnetic core 253 that magnetically couples the first coil 252_1 and the second coil 252_2. The second coil 252_2 is electrically connected to the load 104 through an electrically conductive connection such as electrical cabling or wiring.

A first side of the VFI 230 is electrically connected to the conductor 216 by a first electrical connection assembly 271. The first electrical connection assembly 271 includes one or more flexible electrical conductors. For example, the first electrical connection assembly 271 may include flexible straps of electrically conductive material and/or braided electrical wires. In some implementations, the first electrical connection assembly 271 includes copper flex straps and braided flexible copper wires.

A second side of the VFI 230 is electrically connected to the first coil 252_1 by a second electrical connection assembly 273. The second electrical connection assembly 273 includes a rigid electrically conductive bus that is electrically connected to the second side of the VFI 230. The second electrical connection assembly 273 also may include flexible or non-rigid components. For example, the second electrical connection assembly 273 may include electrically conductive cabling that connects the rigid electrically conductive bus to the first coil 252_1 and/or to another component (such as a fuse) between the VFI 230 and the coil 252_1. The rigid electrically conductive bus may be, for example, a copper bus.

FIG. 2B is a side cross-sectional block diagram of the VFI 230. The VFI 230 includes a housing 236 that encloses a stationary contact 234b and a moveable contact 234a in an evacuated space. The stationary contact 234b is at an end of a stationary rod 235b, and the moveable contact 234a is at an end of a moveable rod 235a. The moveable rod 235a and the stationary rod 235b extend through the housing 236 and are accessible from an exterior of the housing 236. In the example shown, the moveable rod 235a and the stationary rod 235b extend through opposite sides of the housing 236. However, other implementations and configurations of the VFI 230 are possible. Moreover, the VFI 230 may include other components that are known in the art. For example, bellows may surround the moveable operating rod 235a, and the housing 236 may include end caps.

The contacts 234a, 234b and the rods 235a, 235b are made of an electrically conductive material such as, for example, brass, copper, silver, or another metallic material. When the stationary contact 234b is in contact with the moveable contact 234a, the VFI 230 is in the closed state and electrical current flows through the VFI 230 and to the transformer 250. When the contacts 234a and 234b are separated (such as shown in FIG. 2B), the VFI 230 is in the open state and current does not flow through the VFI 230.

The state of the VFI 230 is controlled by actuating a motion control mechanism 237. The motion control mechanism 237 includes one or more components that are configured to drive the moveable operating rod 235a. For example, the motion control mechanism 237 may include a motor, gear assembly, shaft, rod, spring, actuator, or a combination of such devices that move the moveable rod 235a in the Z direction to open the VFI 230 and in the −Z direction to close the VFI 230.

Returning to FIG. 2A, the transformer apparatus 240 also includes a sensor system 280. The sensor system 280 includes any type of device configured to measure current through a conductor and to provide an indication of the measured current. The indication of the measured current may be a numerical value that directly represents the measured current or a measured value (for example, a voltage value) from which the current may be derived. Examples of sensors that may be used in the sensor system 280 include, without limitation, cored current sensors, coreless current sensors, and a shunt resistor with an isolation analog-to-digital converter (such as a power operational amplifier). Examples of cored current sensors include, without limitation, iron core current transformers (CTs) or air core CTs (that is, a Rogowski coil). A Hall sensor is an example of a coreless current sensor, and other coreless current sensors may be used in the sensor system 280. Additionally, low-energy analog (LEA) current sensors may be used. Furthermore, the sensors system 280 may include one or more voltage sensors. A voltage sensor is any device configured to measure voltage across a circuit or at a particular point or node relative to ground or another reference potential. The sensor system 280 is shown as being inside the housing 241 but may be placed outside of the housing 241. For example, the sensor system 241 may be on the exterior of the wall 241a and around the bushing 218 such that a cable connected to the bushing passes through the sensor system 241.

The transformer apparatus 240 may include additional components. For example, the transformer apparatus 240 may include an electronic control system that has an electronic processor, an electronic memory, and an input/output interface. Additionally, the transformer apparatus 240 may include fuses, breakers, visible break or disconnect mechanisms, valves, pumps, and/or braces.

During operational use, the wall 241a is grounded. The second electrical connection assembly 273 and the transformer 250 form an L-C circuit. The transformer 250 has a known inductance (L) that depends on the material, length, diameter, and number of turns in the electrically conductive coils 252_1 and 252_2 and the material of the core 253. The second electrical connection assembly 273 also may have a non-negligible inductance that is also known or can be determined. The capacitance (C) of the L-C circuit depends on the distance between the grounded wall 241a and the L-C circuit as well as the characteristics of electrical insulating material between the grounded wall 241a and the L-C circuit. Like the inductance, the capacitance of the L-C circuit can be determined. Opening and closing the VFI 230 causes a transient voltage spike (a switching transient) that can flow into the L-C circuit. The fundamental frequency of the switching transient is determined by characteristics of the VFI 230 and is known or may be determined.

If the fundamental frequency of the switching transient is the same as the resonant frequency of the L-C circuit, the switching transient may be multiplied (that is, the amplitude of the switching transient may increase) and may damage the transformer 250. In the transformer assembly 240, the L-C circuit is positioned relative to the grounded wall 241a such that the fundamental frequency of the switching transient is not the same as the resonant frequency of the L-C circuit. This reduces the amplitude of the voltage that the transformer 250 is exposed to due to switching transients and increases the lifetime of the transformer 250. Moreover, the L-C circuit may be configured to minimize the impact of switching transients on the transformer 250.

Equations (1) to (4) model the design parameters for the transformer apparatus 240.

$$f ( Transformer ) = 1 / 2 π √ ( LC ) ; \qquad Equation ( 1 )$$

$$f ( VFI ) ∝ K * RRRV ; \qquad Equation ( 2 )$$

$$K = ( \frac{{V}_{TRV}}{{V}_{nom}} ) * {v}_{VFI} * MF ; \qquad Equation ( 3 )$$

$$and$$

$$f ( Transformer ) \neq f ( VFI ) , \qquad Equation ( 4 )$$

where f(Transformer) is the resonant frequency of an L-C circuit that includes the transformer 250 and the second electrical connection assembly 273 (and may include additional components), f(VFI) is the fundamental frequency of the switching transient, RRRV is the Rate of Rise of Restrike Voltage, K is a correction factor for RRRV, V_{TRV} is the peak voltage amplitude of the switching transient, Vnom is the nominal system voltage, υ_{VFI} is the velocity of the moving contact of the VFI 230 or the speed at which the VFI 230 opens and closes, and MF is a material factor of the VFI 230. The RRRV is related to the steepness of the switching transient. The MF of the VFI 230 is based on the characteristics of the materials that make up the contacts 234a, 234b and the geometry of the contacts 234a, 234b.

As shown in Equation (4), one of the design parameters is that the resonant frequency of the L-C circuit cannot be the same as the fundamental frequency of the switching frequency. Temperature and other environmental factors can affect L-C circuit such that the resonant frequency has a finite bandwidth. In some implementations, the design parameter shown in Equation (4) is satisfied when f(Transformer) and f(VFI) are different by a pre-determined threshold amount. For example, f(Transformer) and f(VFI) may be considered different when there is at least 1 kHz difference between f(Transformer) and f(VFI). Moreover, in some implementations, the harmonics of f(Transformer) are also considered. In these implementations, Equation (4) is considered for f(Transformer) and also for harmonics of f(Transformer). To provide an example, if the L-C resonant frequency f(Transformer) is 240 kHz, then f(VFI) cannot equal 240 kHz, nor can f(VFI) equal harmonics of this frequency such as 480 kHz or 960 kHz. Although higher order harmonics are less likely to cause multiplication of the switching transient, performance may be further improved by considering the harmonics.

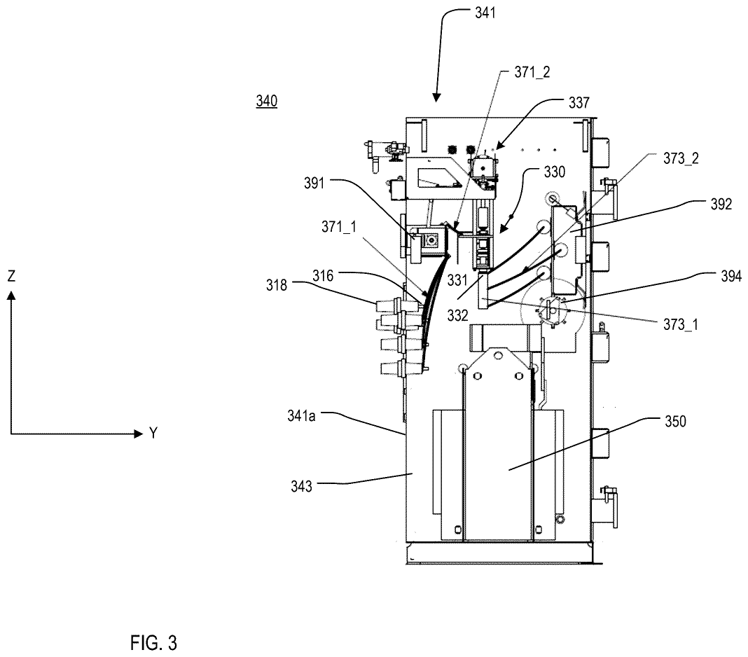

FIG. 3 is a side cross-sectional view of a three-phase transformer apparatus 340. The transformer apparatus 340 includes a housing 341 with a front wall 341a that extends generally in the X-Z plane. Bushings 318 extend through the front wall 341a and provide electrical insulation to conductors 316. Although only one input bushing 318 is labeled, the transformer apparatus 340 includes three input bushings 318, one for each phase.

The housing 341 defines an interior 343 and encloses a switching assembly 330 and a transformer 350. The interior 343 also may contain an electrically insulating fluid. The switching assembly 330 includes three vacuum fault interrupters (VFIs) and a motion control mechanism 337 that opens and closes the VFIs simultaneously. Each VFI of the switching assembly 330 is similar to the vacuum fault interrupter 230 shown in FIGS. 2A and 2B. The transformer 350 includes electrically conductive coils and a magnetic core. FIG. 3 shows an exterior view of the transformer 350 and the coils and core are not shown. However, each phase of the transformer 350 may be similar to the transformer 250 of FIG. 2A.

The conductors 316 are electrically connected to a first electrical connection assembly that is electrically connected to a first side 331 of the switching assembly 330. The first electrical connection assembly includes flexible electrically conductive straps 371_1 and flexible electrically conductive wires 371_2. In the implementation shown in FIG. 3, the straps 371_1 are electrically connected to a visible disconnect 391, which is also electrically connected to the wires 371_2. The straps 371_1 may be straps of copper, brass, silver, gold, or any other electrically conductive material. The wires 371_2 may be braided wires or cables and are made of any electrically conductive material. For example, the wires 371_2 may be copper, brass, silver, or gold. Each conductor 316 is connected to a different strap 371_1, and each flexible electrically conductive wire 371_2 is electrically connected to the input terminal of one VFI. The output terminals of the VFIs are on a second side 332 of the switching assembly 330 and are electrically connected to a rigid electrically conductive bus assembly 373_1.

The rigid electrically conductive bus assembly 373_1 includes one bus for each phase. Thus, the three-phase transformer apparatus 340 includes three distinct busses. Each bus is spatially separated from the other busses to provide electrical isolation. For example, each bus may be three inches from any other bus. Each bus of the rigid electrically conductive bus 373_1 is made of any electrically conductive material and may be made of copper.

Each bus is a bar or rod of electrically conductive material that connects the output terminal of the VFI in one of the three phases to a conductive cable 373_2. In the example of FIG. 3, there are three busses and three electrically conductive cables 373_2. The transformer apparatus 340 may include a single three-phase switching assembly 330. In these implementations, the output of each of the three VFIs of the switching assembly 330 is electrically connected to one of the busses. The transformer apparatus 340 may be implemented in a dual-source configuration with two line-side three-phase switching apparatuses 330. In these implementations, the rigid assembly 373_1 still includes one bus for each phase, and the output terminals of the two VFIs in each phase are electrically connected to one bus.

The conductive cables 373_2 are electrically connected to the transformer 350 through a fuse assembly 392. The fuse assembly 392 may include any type of fuse and may include one fuse per phase. In some implementations, the fuse assembly 392 includes three current limiting fuses, one for each phase. The output coil (not shown) of the transformer 350 is electrically connected to a load (not shown).

In operational use of the transformer apparatus 340, the front wall 341a is grounded, and each input bushing 318 is connected to a phase of a source. Under typical and normal operating conditions, the VFIs of the switching assembly 330 are closed. The motion control mechanism 337 opens the VFIs to interrupt fault current, prepare for maintenance, and for other temporary conditions, and the mechanism 337 closes the VFIs after the condition has passed. The VFIs produce switching transients during open and close operations, and the switching transients have a fundamental frequency determined by the properties of the VFIs. The rigid electrically conductive bus 373_1, the cables 373_2, and the transformer 350 define an L-C circuit with a resonant frequency that depends on the inductance and capacitance of the circuit. The inductance of the L-C circuit depends on the characteristics of the transformer coils and the core. The capacitance depends on the distance between the rigid electrically conductive bus 373_1 and the grounded wall 341a. The rigid electrically conductive bus 373_1 is positioned in the interior 343 such that the resonant frequency of the L-C circuit is not the same as the fundamental frequency of the switching transient.

Legacy transformers included braided electrically conductive wire to make internal electrical connections. On the other hand, the transformer apparatus 340 includes a collection of flexible and rigid electrical connections, namely, the straps 371_1, the braided wires 371_2, the rigid bus 373_1, and the cables 373_2. As compared to the legacy braided wire, the straps 371_1 are a shorter length and create a more rigid body that eliminates the need for additional stabilizers, such as tie-offs to the internal wall for stability. The flexible nature of the straps 371_1, the braided wires 371_2, and the cables 373_2 allow the transformer apparatus 340 to have a more compact design than a legacy transformer that lacks a collection of flexible and rigid electrical connections. Furthermore, due to its configuration, the transformer apparatus 340 may have voltage and current ratings comparable to or greater than the legacy transformer. Moreover, by using the straps 371_1, the wires 371_2, and the cables 373_2 together with the rigid electrically conductive bus 373_1, the electrically conductive bus 373_1 may be precisely positioned and held in a stable manner relative to the front wall 341a to fine tune and set the amount of capacitance in the L-C circuit.

These and other implementations are within the scope of the claims.

What is claimed is:

1. A system comprising:
a housing that defines an interior configured to receive an electrically insulating fluid;
a transformer comprising an electrically conductive coil assembly in the interior;
a switching assembly in the interior, the switching assembly comprising:
an input side;
an output side; and
a switch device that electrically connects the input side and the output side in a closed state and electrically isolates the input side and the output side in an opened state;
a connection assembly that passes through the housing;
a flexible electrical connection that electrically connects the connection assembly and the input side of the switching assembly;
a rigid electrically conductive bus electrically connected to the output side of the switching assembly; and
electrically conductive cable electrically connected to the rigid electrically conductive bus and the transformer.

2. The system of claim 1, wherein the electrically conductive coil assembly, the rigid electrically conductive bus, and the electrically conductive cable are associated with a first resonant frequency; and the switching assembly is associated with a second resonant frequency that is different from the first resonant frequency.

3. The system of claim 2, wherein the first resonant frequency depends on an inductance of the electrically conductive coil assembly and a spatial distance between a portion of the housing configured to be grounded during use and the rigid electrically conductive bus.

4. The system of claim 2, wherein the second resonant frequency is associated with a voltage transient produced by a switching operation of the switching assembly.

5. The system of claim 4, wherein the second resonant frequency is a fundamental frequency of the voltage transient produced by the switching operation of the switching assembly.

6. The system of claim 1, wherein the switching assembly comprises vacuum interrupters, and each of the vacuum interrupters comprises a moving contact and a stationary contact.

7. The system of claim 1, wherein the connection assembly comprises bushings, and each of the bushings comprises an electrical conductor that is electrically connected to the flexible electrical connection.

8. A transformer comprising:
a housing comprising: a wall configured to be grounded during use of the transformer, an interior, and a bushing that extends through the wall;
a vacuum interrupter in the interior;
an electromagnetic circuit in the interior, the electromagnetic circuit comprising an electrically conductive coil;
a flexible electrical connection assembly in the interior, the flexible electrical connection electrically connected to the bushing and to a first electrical terminal of the vacuum interrupter; and
an electrical lead assembly in the interior and comprising a rigid electrically conductive bus, the electrical lead assembly electrically connected to a second electrical terminal of the vacuum interrupter and to the electromagnetic circuit, wherein the electrical lead assembly and the electrically conductive coil are associated with a first resonant frequency, the vacuum interrupter is associated with a second resonant frequency, and the electrical lead assembly is positioned in the interior relative to the wall such that the first resonant frequency and the second resonant frequency are not the same.

9. The transformer of claim 8, wherein the second resonant frequency is based on the rate of rise of restrike voltage (RRRV) of the vacuum interrupter.

10. The transformer of claim 8, wherein the second resonant frequency is a fundamental frequency of a voltage transient produced by one or more of opening and closing the vacuum interrupter.

11. The transformer of claim 8, wherein the electrical lead assembly further comprises electrically conductive cables.
